(19) United States
(12) Patent Application Publication
(10) Pub. No.: US 2026/0342659 A1
(43) Pub. Date: Oct. 29, 2026

(54) AF INFLUENCE ON POLICY EVALUATION

(71) Applicant: Telefonaktiebolaget LM Ericsson (publ), Stockholm (SE)

(72) Inventors: Ping CHEN, Shanghai (CN); Ignacio RIVAS MOLINA, Madrid (ES); Emiliano MERINO VAZQUEZ, Madrid (ES)

(73) Assignee: Telefonaktiebolaget LM Ericsson (publ), Stockholm (SE)

(21) Appl. No.: 19/099,770

(22) PCT Filed: Aug. 16, 2023
(86) PCT No.: PCT/EP2023/072598

§ 371 Date: Jan. 29, 2025

(30) Foreign Application Priority Data
Sep. 1, 2022 (WO) PCT/CN2022/116532

(51) Int. Cl. H04L 41/0894; H04M 15/00

(52) U.S. Cl. CPC H04L 41/0894; H04M 15/66

(57) ABSTRACT

According to an aspect, there is provided a method of operating a Policy and Charging Function, PCF, (202) in a communication network to effect a change in Quality of Service, QoS, for a User Equipment, UE. The method comprises sending (601), to a Unified Data Repository, UDR, in the communication network, a request for policy data and/or application data for the UE; receiving (603), from the UDR (203), information identifying the UE and one or both of a start time for a change in QoS for the UE and a duration of the change in QoS for the UE; and sending (605), to a Session Management Function, SMF, (201) a message comprising (i) a first event trigger for the change in QoS that is based on the start time and/or duration; or (ii) a QoS for the SMF (201) to use for a session that is sent after the start time or on expiry of the duration.

### TECHNICAL FIELD

This disclosure relates to one or more of a 5th Generation (5G) Core (5GC), an Application Function (AF), a Network Exposure Function (NEF), a Policy and Charging Function (PCF), network capability exposure, policy and charging control, and reporting of a presence reporting area (PRA). The main use cases described herein relate to changing Quality of Service (QoS) policies for a User Equipment (UE) based on a request from an external party.

### BACKGROUND

In 5th Generation (5G) networks, a service-based architecture has been introduced for the core network, which is broken down into communicating services known as Network Functions (NFs). FIG. 1 illustrates a 5G system reference architecture 101 showing service-based interfaces used within the Control Plane (CP). It will be appreciated that not all types of NF instances/NF service are depicted. Service-based interfaces are represented in the format Nxyz and point to point interfaces in the format Nx. The reference architecture 101 shown in FIG. 1 comprises the following types of NF instance: a Network Slice Selection Function (NSSF) 102 that has a Nnssf interface, a Network Exposure Function (NEF) 103 that has a Nnef interface, a Network Repository Function (NRF) 104 that has a Nnrf interface, a Policy Control Function (PCF) 105 that has a Npcf interface, a Unified Data Repository (UDR) 106 that has a Nudr interface, an Application Function (AF) 107 that has a Naf interface, an Authentication Server Function (AUSF) 108 that has a Nausf interface, an Access and Mobility Management Function (AMF) 109 that has a Namf interface, a Session Management Function (SMF) 110 that has a Nsmf interface, a Service Communication Proxy (SCP) 111 with a Nscp interface and a Unified Data Management (UDM) 116 that has a Nudm interface.

The AMF 109 has an N1 interface to a user equipment (UE) 112, and an N2 interface to a radio access network (AN) 113 (which can be a radio AN, RAN). The SMF 110 has an N4 interface to a User Plane Function (UPF) 114. The interface between the R(AN) 113 and the UPF 114 is the N3 interface, and the interface between the UPF 114 and a Data Network (DN) 115 is the N6 interface.

The Third Generation Partnership Project (3GPP) Technical Specification (TS) 23.501 (System architecture for the 5G System (5GS); Stage 2) v17.4.0 clause 5.2 defines a framework for external exposure of network capabilities, via the Network Exposure Function (NEF). This includes the exposure of Policy/Charging capability for a User Equipment (UE) based on a request from an external party.

3GPP TS 23.503 (Policy and charging control framework for the 5G System (5GS); Stage 2) v17.4.0 clause 4.2.6 specifies the following non-session management-related network capability exposure of policy control functionality from the NEF:
Management of Packet Flow Descriptions (PFDs)
Negotiations for future background data transfer (BDT)
Applying a previously negotiated background data transfer policy to a UE or group of UEs
Traffic steering control for Application Function (AF) influenced traffic diversion
Service specific parameter provisioning for Vehicle-to-Everything (V2X) communication
5G Virtual Network (VN) group management
Service specific parameter provisioning for Proximity Services (ProSe) functionality
Service specific parameter provisioning for time synchronization service

The procedures above allow the AF to provide, via the NEF, policy requirements for specific use cases (BDT, traffic steering, 5G VN group, ProSe, etc), that target any existing or future Protocol Data Unit (PDU) sessions for multiple UE(s) or of any UE.

After relevant validation of the AF request (and possible parameter mapping), the NEF stores this request received from the AF into the selected Unified Data Repository (UDR) instance as the Data Subset of the Application data. The PCF subscribes to receive notifications from the UDR about such AF request information, and takes into account the policy requirements received from the AF when making policy decisions for existing and future relevant PDU sessions.

Presence Reporting Area (PRA) is specified as a UE entering a geographical area, e.g. as defined by a list of radio cell identifiers. PRA may be used to evaluate policies and determine different outcomes by PCF, such as zero charging when a UE enters PRA or leaves PRA. The PCF may request a Session Management Function (SMF) receive notifications when a given UE/user enters or leaves the area/PRA. This can be done with event PRA_CHG (PRA change).

Also, Time Of Day (ToD) policies can be used separately or together with PRA, so that a PCF can instruct a SMF to reauthorize the data session when a time and date are reached, for example, to upgrade the QoS when a certain point in time is reached and during a specific duration.

3GPP has defined the possibility to provision operator specific data (OSD) as part of PCF policy subscription data. OSD is pre-provisioned statically by the operator (via a provisioning system) in the UDR, and may be also modified by the PCF. It should be noted that the content and format/encoding of operator specific data and operator specific data sets are not subject to standardization.

### SUMMARY

There currently exist certain challenge(s).

Currently, 3GPP specifications allow an external party (A)F to provide, via the NEF, policy requirements for specific use cases, as described above. However, network operators require the support of additional use cases, that are not currently covered by 3GPP.

In a first example, a network operator may require a functionality relating to users that can purchase or obtain data rate boosts (‘turbo-speed’). When a user purchases a turbo-speed, they could log in to a web page associated with the network operator, and then decide when the service (high(er) speed/high(er) bit rate) is to be started, and the duration of the turbo-speed. The network operator therefore needs to be able to modify the ToD policies so that the time window to upgrade the QoS is dynamically configured after the user's interaction with their web service.

In a second example, a network operator may wish to have the possibility to have “local-SIMs” (Subscriber Identity Modules), which are intended to provide data connectivity only when the owners (e.g. hospital employees) of the SIM are moving within certain areas (e.g. a hospital). Then, only when the users enter or are in those geographical areas, the data connectivity is allowed. Otherwise, if they are outside the associated “home” geographical area, data connectivity is forbidden or restricted (e.g. to certain services, lower QoS, additional charging, etc). As in the first example, this second example results in the network operator requesting the possibility to assign PRAs to specific UEs in a dynamic fashion, so that the PCF evaluates policies based on this/these PRAs. Again, no standard or standardised mechanism exists for this.

In general, there is no mechanism for an external party to provide specific AF information to influence policy decisions, that is not currently included in either policy subscription data or associated to the specific use cases described above. Extensions to policy subscription data stored in the UDR (e.g. vendor-specific information, operator-specific information) are not intended to be managed by an external party (i.e. Application Server, vertical), but to be managed by the network operator Operations Support System (OSS)/Business Support System (BSS) provisioning system.

Certain aspects of the disclosure and their embodiments may provide solutions to these or other challenges.

The Application Server (AS)/AF (external party) provides to a NEF a set of specific AF information that can be used to influence policy decisions for a UE, a group of UEs or any UE. The NEF can store the received AF information in the UDR. The content, meaning and format/encoding of such container of AF-specific information can be the result of an agreement between the AS/AF and the network operator (NEF/PCF).

For existing PDU sessions, the PCF can subscribe to receive notifications from the UDR about such AF-specific information. For new PDU sessions, the PCF may read the AF-specific information from the UDR if it is not already available in the local cache. The PCF can then take into account the AF-specific information when making policy decisions.

A realization of the specific use cases outlined in the two examples above would be as follows.

Overall solution: Policy data can be exposed via NEF (Network Exposure Function) by extending Nnef_Service_Parameter Application Programming Interface (API), which will allow either to store it as application data in UDR (e.g. in a new resource such as: /application-data/policy-influence/af-specific-data), or store it directly as policy-data (e.g. in a new resource such as: /policy-data/af-specific-data). This data can be stored in the UDR and fetched by the NEF so that it can be evaluated in PCF policies. The PCF can then determine whether the QoS is to be upgraded (e.g. turbo-speed) or the data connectivity is allowed (local-SIMs).
1) The AF (e.g. a web application server where a ‘turbo-speed’ service can be purchased) can call a Nnef_Service_Parameter API and includes a new “AF influence in policy data” element, e.g. containing a start time and duration so that the turbo-speed service is enabled for the user requesting it.
2) The NEF can store the new “AF influence on policy data” in the UDR, either as part of application data, or as part of policy data. This can be decided by the NEF based on new local policies or enhanced Network Repository Function (NRF) discovery.
3) The PCF can retrieve the information from the UDR and take it into account to evaluate policies.

The techniques in this disclosure enable an external party AF/AS to influence policy/charging control decisions according to a pre-defined set of data and business logic that results from an agreement between the external party (AS/AF) and the network operator (NEF/PCF).

The above solution can be used to satisfy both of the network operator use-case examples, since the ultimate goal of the network operator in these examples is to let the AF influence policy evaluation performed by PCF, either by setting a new ToD policy (e.g. a turbo-speed button), or by setting a PRA policy (e.g. local-SIMs).

Certain embodiments may provide one or more of the following technical advantage(s). In particular, embodiments provide a new mechanism to allow authorized AFs to influence policy evaluation performed by PCF in a dynamic manner, that is, without the need for the network operator to provision information statically via their provisioning system.

This new mechanism can enable external third party AF/AS to define new use cases for policy and charging control, based on a previous agreement between the external party (AS/AF) and the network operator (NEF/PCF).

Various aspects and embodiments are described herein.

In particular, according to a first aspect, there is provided a method of operating an AF to effect a change in QoS for a UE. The method comprises sending, to a NEF in a communication network, a message identifying the UE and one or both of a start time for a change in QoS for the UE and a duration of the change in QoS for the UE.

According to a second aspect, there is provided a method of operating a NEF in a communication network to effect a change in QoS for a UE. The method comprises receiving, from an AF a message identifying the UE and one or both of a start time for a change in QoS for the UE and a duration of the change in QoS for the UE; and sending information identifying the UE and the one or both of the start time and duration to a UDR in the communication network.

According to a third aspect, there is provided a method of operating a UDR in a communication network to effect a change in QoS for a UE. The method comprises receiving, from a NEF, information identifying the UE and one or both of a start time for a change in QoS for the UE and a duration of the change in QoS for the UE; storing the received information; and sending the information identifying one or both of the start time and duration of the change in QoS for the UE to a PCF in response to a request from the PCF for policy data and/or application data for the UE.

According to a fourth aspect, there is provided a method of operating a PCF in a communication network to effect a change in QoS for a UE. The method comprises: sending, to a UDR in the communication network, a request for policy data and/or application data for the UE; receiving, from the UDR, information identifying the UE and one or both of a start time for a change in QoS for the UE and a duration of the change in QoS for the UE; and sending, to a SMF a message comprising (i) a first event trigger for the change in QoS that is based on the start time and/or duration; or (ii) a QoS for the SMF to use for a session that is sent after the start time or on expiry of the duration.

According to a fifth aspect, there is provided a method of operating a SMF in a communication network to effect a change in QoS for a UE. The method comprises: receiving, from a PCF in the communication network, a message comprising a first event trigger for the change in QoS that is based on a start time for the change in QoS for the UE and/or a duration of the change in QoS for the UE; establishing a data session for the UE and monitoring for occurrence of the first event trigger; after the first event trigger occurs, sending a request to the PCF to reauthorise the data session; and receiving, from the PCF, updated policy data for the UE that effects the change in QoS.

According to a sixth aspect, there is provided a method of operating an AF to effect control of data sessions according to location of a UE. The method comprises: sending, to a NEF in a communication network, a message identifying the UE and a geographic area in which a data session for the UE is to be permitted or prevented.

According to a seventh aspect, there is provided a method of operating a NEF in a communication network to effect control of data sessions according to location of a UE. The method comprises: receiving, from an AF, a message identifying the UE and a geographic area in which a data session for the UE is to be permitted or prevented; and sending information identifying the UE and the geographic area to a UDR in the communication network.

According to an eighth aspect, there is provided a method of operating a UDR in a communication network to effect control of data sessions according to location of a UE. The method comprises: receiving, from a NEF, information identifying the UE and a geographic area in which a data session for the UE is to be permitted or prevented; storing the received information; and sending the information identifying the geographic area to a PCF in response to a request from the PCF for policy data and/or application data for the UE.

According to a ninth aspect, there is provided a method of operating a PCF in a communication network to effect control of data sessions according to location of a UE. The method comprises: sending, to a UDR in the communication network, a request for policy data and/or application data for the UE; receiving, from the UDR, information identifying the UE and a geographical area in which a data session for the UE is to be permitted or prevented; and sending, to a SMF, a message comprising a first event trigger for the control of data sessions for the UE.

According to a tenth aspect, there is provided a method of operating a SMF in a communication network to effect control of data sessions according to location of a UE. The method comprises: receiving, from a PCF in the communication network, a message comprising a first event trigger for the control of data sessions according to location of the UE, wherein the first event trigger is to be triggered if the UE moves into or out of an indicated geographic area; monitoring the location of the UE for occurrence of the first event trigger; after the first event trigger occurs, sending a request to the PCF for policy data for a data session, wherein the request indicates whether the UE is inside or outside of the geographic area; and receiving, from the PCF, updated policy data for the UE that indicates whether a data session for the UE is permitted.

According to an eleventh aspect, there is provided a computer program product comprising a computer readable medium having computer readable code embodied therein, the computer readable code being configured such that, on execution by a suitable computer or processor, the computer or processor is caused to perform the method according to any of the first to tenth aspects.

According to a twelfth aspect, there is provided a network node configured to perform the method according to any of the first to tenth aspects.

According to a thirteenth aspect, there is provided a network node comprising a processor and a memory, said memory containing instructions executable by said processor whereby said network node is operative to perform the method according to any of the first to tenth aspects.

### BRIEF DESCRIPTION OF THE DRAWINGS

Some of the embodiments contemplated herein will now be described more fully with reference to the accompanying drawings, in which:

FIG. 1 illustrates a 5G system reference architecture showing service-based interfaces used within the control plane;

FIG. 2 is a signalling diagram illustrating the signalling between different network functions according to the disclosed techniques in order to effect a change in QoS by an external AF;

FIG. 3 is a flow chart illustrating a method of operating an AF to effect a change in QoS for a UE;

FIG. 4 is a flow chart illustrating a method of operating a NEF to effect a change in QoS for a UE;

FIG. 5 is a flow chart illustrating a method of operating a UDR to effect a change in QoS for a UE;

FIG. 6 is a flow chart illustrating a method of operating a PCF to effect a change in QoS for a UE;

FIG. 7 is a flow chart illustrating a method of operating a SMF to effect a change in QoS for a UE;

FIG. 8 is a signalling diagram illustrating the signalling between different network functions according to the disclosed techniques in order to effect the enabling or disabling of data connectivity according to a geographical area in which the UE is located;

FIG. 9 is a flow chart illustrating a method of operating an AF to effect control of data sessions according to location of a UE;

FIG. 10 is a flow chart illustrating a method of operating a NEF to effect control of data sessions according to location of a UE;

FIG. 11 is a flow chart illustrating a method of operating a UDR to effect control of data sessions according to location of a UE;

FIG. 12 is a flow chart illustrating a method of operating a PCF to effect control of data sessions according to location of a UE;

FIG. 13 is a flow chart illustrating a method of operating a SMF to effect control of data sessions according to location of a UE;

FIG. 14 is a simplified block diagram of a network node according to some embodiments; and

FIG. 15 is a block diagram illustrating a virtualization environment in which functions implemented by some embodiments may be virtualized.

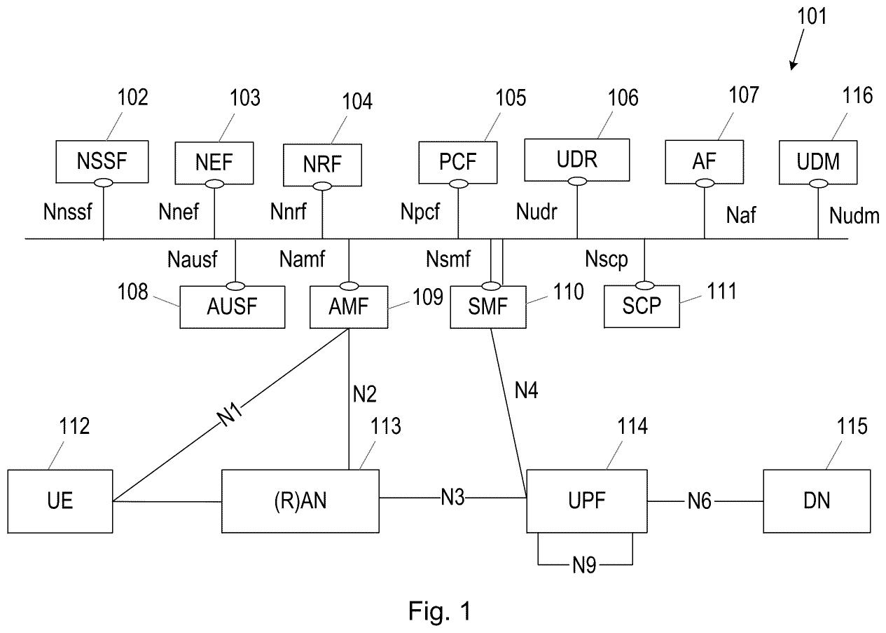

### DETAILED DESCRIPTION

Some of the embodiments contemplated herein will now be described more fully with reference to the accompanying drawings. Embodiments are provided by way of example to convey the scope of the subject matter to those skilled in the art.

As noted above, the solutions provided in this disclosure enable an external party AF/AS to influence policy/charging control decisions according to a pre-defined set of data and business logic that results from an agreement between the external party (AS/AF) and the network operator (NEF/PCF).

Briefly, the disclosed solution extends the Nnef_Service_Parameter Application Programming Interface (API) so that policy data can be exposed via the NEF, which will allow the NEF to either store it as application data in UDR (e.g. in a new resource such as: /application-data/policy-influence/af-specific-data), or store it directly as policy-data (e.g. in a new resource such as: /policy-data/af-specific-data). This data can be stored in the UDR and fetched by the NEF so that it can be evaluated in PCF policies. The PCF can then determine an appropriate policy modification, e.g. an upgraded QoS, or allowance of data connectivity in a particular geographical location.

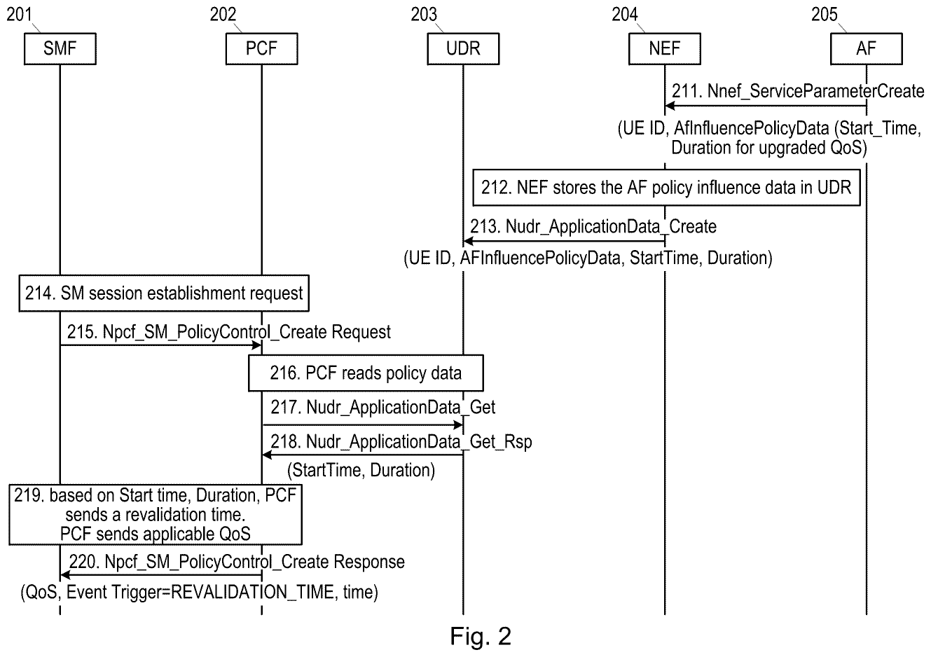

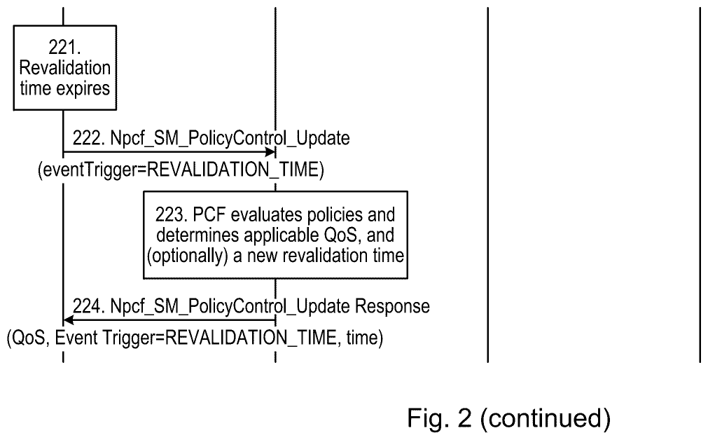

FIG. 2 is a signalling diagram illustrating the signalling between different network functions according to the disclosed techniques in order to effect a change in QoS by an external application function (AF). In this example, a network operator or other external party provides a functionality relating to users that can purchase or obtain data rate boosts ('turbo-speed'). In particular, when a user purchases a turbo-speed/speed boost/higher data rate, they could log in to a web page associated with the network operator, and then decide when the service (high(er) speed/high(er) bit rate) is to be started, and the duration of the high(er) speed. The external party/network operator therefore needs to be able to modify the ToD policies so that the time window to upgrade the QoS is dynamically configured after the user's interaction with their web service.

FIG. 2 shows the signalling between an SMF 201, PCF 202, UDR 203, NEF 204 and AF 205.

At step 211, the AF 205 sends a message to the NEF 204 that identifies the affected UE(s), indicates when/how long the change to the QoS is required, and optionally what the QoS upgrade is (for example a specific data rate that is requested or required, a general QoS level, e.g. ‘high’, etc.). This information is generally referred to herein as the AF influence policy data (i.e. data from the AF 205 that is used to influence policy) or AfInfluencePolicyData. In some embodiments, the message sent by the AF 205 in step 211 can call the Nnef_Service_Parameter API, and can be a Nnef_ServiceParameterCreate message.

At step 212, the NEF 204 decides that the AF influence policy data is to be stored in the UDR 203 and at step 213 the NEF 204 sends a message to the UDR 203 to store the AF influence policy data in the UDR 203. The target resource/storage in the UDR 203 (e.g. /application-data or/policy-data) can either be based on a new local policy in the NEF 204, or be based on a response from a NRF when discovering UDRs (depending on whether a UDR service is discovered for application-data and the AF influence on policy data subset). The message sent by the NEF 204 to the UDR 203 can be a Nudr_ApplicationData_Create message and can include the AF influence policy data received from the AF 205.

At step 214, a new session management (SM) session for a UE is to be established, and in step 215 the SMF 201 sends a message to the PCF 202 to obtain policy information for the new SM session. A new SM session may be established when a UE is attached to the network and requests data connectivity. The message sent by the SMF 201 can be a Npcf_SM_PolicyControl_Create message.

Following receipt of the request from the SMF 201, the PCF 202 determines that it needs to read the policy data and the application data for the UE that is stored in the UDR 203. In step 216 the PCF 202 obtains the policy data from the UDR 203, and in step 217 the PCF 202 sends a request to the UDR 203 for the policy and/or application data for the UE. This request can be a Nudr_ApplicationData_Get message.

In step 218 the UDR 203 sends the policy and/or application data for the UE to the PCF 202. In this embodiment, the policy and application data includes a start time and/or duration of the enhanced QoS, and may also provide information relating to the enhanced QoS, particularly if different levels of QoS upgrade are available. This data can be sent in a Nudr_ApplicationData_Get_Rsp message.

In step 219, based on the start time/duration information, the PCF 202 updates the policies in the SMF 201 with the applicable QoS and includes a revalidation event that is triggered by the start time being reached or by the duration expiring (if the QoS upgrade is started immediately-in which case the QoS may be downgraded (e.g. fall back to the original QoS) on revalidation). The occurrence of the event (e.g. the start time occurring or the duration expiring) is to cause the SMF 201 to request reauthorization/revalidation of the SM session from the PCF 202, allow the PCF 202 to change the required QoS. This is shown by the PCF 202 sending a message to the SMF 201 in step 220 indicating the QoS to apply and the time at which the session is to be revalidated by the PCF 202. The QoS indicated to the SMF 201 at this stage can be the upgraded QoS (if the upgrade is to start immediately, e.g. for the specified ‘duration’), or a ‘standard’ QoS (if the upgrade is to start at a later time (the ‘start time’)). The revalidation time can be equal to the start time plus the duration (if the upgraded QoS session has not yet started and it is to start at a later time). The message sent in step 220 can be a Npcf_SM_PolicyControl_Create Response message (i.e. a response to the message sent in step 215).

When the revalidation time expires/is met (step 221), the SMF 201 sends a message 222 to the PCF 202 indicating the expiry and requests reauthorisation/revalidation of the session. This message 222 can be a Npcf_SM_PolicyControl_Update message, and can indicate the occurrence of the event trigger. At step 223, the PCF 202 evaluates the policy/ies and determines the applicable QoS. If the applicable QoS is the upgrade, the PCF 202 may also determine a new revalidation time. This information is communicated to the SMF 201 in a message 224. The message 224 may be a Npcf_SM_PolicyControl_Update Response message, and can indicate the QoS, and optionally also indicate a new event trigger for requesting revalidation of the session.

In a first alternative approach to that shown in FIG. 2, rather than the SMF 201 monitoring for the occurrence of the start time or expiry of the duration, the PCF 202 can monitor this directly, and signal the required QoS to the SMF 201 at the appropriate time. In this case, the PCF 202 does not need to include the event trigger in message 220 (or message 224).

In a second alternative approach to that shown in FIG. 2, the PCF 202 can signal the event trigger to the SMF 201 as described above in message 220, and also include (in message 220) the QoS that is to be used after the event trigger occurs. In this alternative, the SMF 201 monitors for the occurrence of the event trigger, and then automatically applies the QoS indicated by the SMF 201 (in which case messages 222 and 224 are not required).

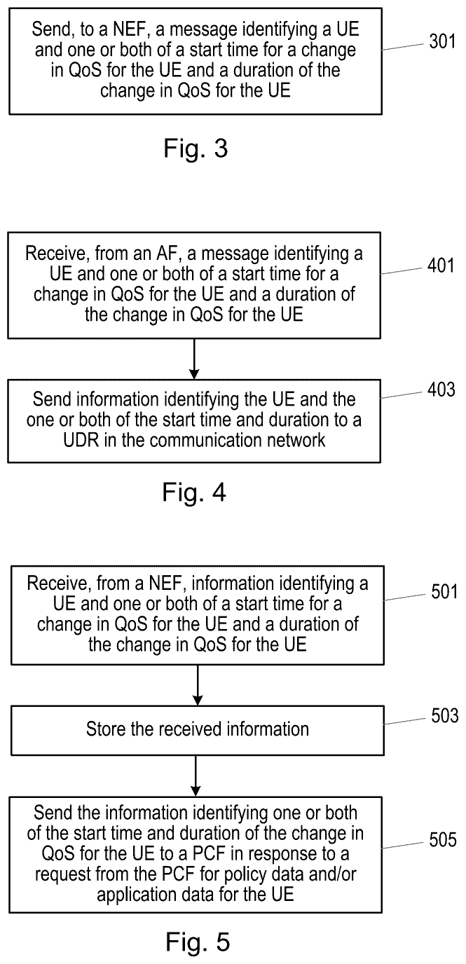

FIG. 3 is a flow chart illustrating a method of operating an AF 205 to effect a change in QoS for a UE. The method may be performed by an AF node 205, or a general network node configured to operate as an AF 205. The AF/network node 205 may perform the method in response to executing suitably formulated computer readable code. The computer readable code may be embodied or stored on a computer readable medium, such as a memory chip, optical disc, or other storage medium. The computer readable medium may be part of a computer program product.

In step 301, the AF 205 sends a message to a NEF 204. The message identifies the UE and one or both of: (i) a start time for a change in QoS for the UE, and (ii) a duration of the change in QoS for the UE. This message can be message 211 in FIG. 2.

The message may further comprise an indication of the change in QoS to be effected at the start time and/or for the duration. The change in QoS may be an increase in data rate provided to the UE by the communication network.

In some cases, the method in FIG. 3 is performed in response to a request to change the QoS sent to the AF 205 from a user of the UE.

FIG. 4 is a flow chart illustrating a method of operating a NEF 204 to effect a change in QoS for a UE. The method may be performed by a NEF node 204, or a general network node configured to operate as a NEF 204. The NEF/network node 204 may perform the method in response to executing suitably formulated computer readable code. The computer readable code may be embodied or stored on a computer readable medium, such as a memory chip, optical disc, or other storage medium. The computer readable medium may be part of a computer program product.

In step 401, the NEF 204 receives a message from an AF 205. The message identifies the UE and one or both of: (i) a start time for a change in QoS for the UE and (ii) a duration of the change in QoS for the UE. This message can be message 211 in FIG. 2.

In step 403, the NEF 204 sends information identifying the UE and the one or both of the start time and duration to a UDR 203 in the communication network. The sending of this information can correspond to message 213 in FIG. 2.

FIG. 5 is a flow chart illustrating a method of operating a UDR 203 to effect a change in QoS for a UE. The method may be performed by a UDR node 203, or a general network node configured to operate as a UDR 203. The UDR/network node 203 may perform the method in response to executing suitably formulated computer readable code. The computer readable code may be embodied or stored on a computer readable medium, such as a memory chip, optical disc, or other storage medium. The computer readable medium may be part of a computer program product.

In step 501 the UDR 203 can receive information identifying the UE (for which the QoS is to be changed), and one or both of: (i) a start time for a change in QoS for the UE and (ii) a duration of the change in QoS for the UE. This information is received from the NEF 204. This information can correspond to message 213 in FIG. 2.

In step 503 the UDR 203 stores the received information.

In step 505, the UDR 203 sends the information identifying one or both of the start time and duration of the change in QoS for the UE to a PCF 202 in response to a request from the PCF 202 for policy data and/or application data for the UE. The sending of this information can correspond to message 218 in FIG. 2.

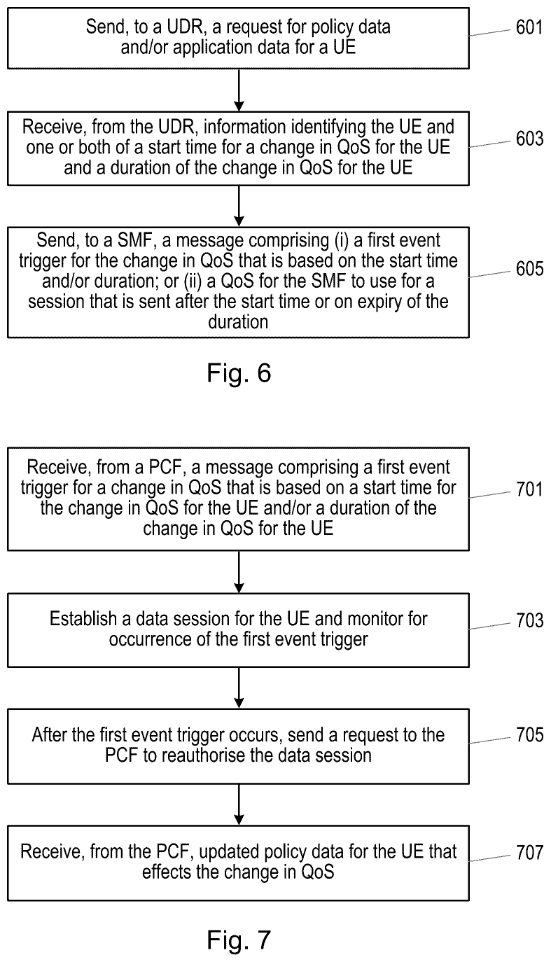

FIG. 6 is a flow chart illustrating a method of operating a PCF 202 to effect a change in QoS for a UE. The method may be performed by a PCF node 202, or a general network node configured to operate as a PCF 202. The PCF/network node 202 may perform the method in response to executing suitably formulated computer readable code. The computer readable code may be embodied or stored on a computer readable medium, such as a memory chip, optical disc, or other storage medium. The computer readable medium may be part of a computer program product.

In step 601 the PCF 202 sends a request for policy data and/or application data for the UE to a UDR 203. This request can correspond to message 217 in FIG. 2.

In step 603 the PCF 202 receives information identifying the UE and one or both of a start time for a change in QoS for the UE and a duration of the change in QoS for the UE. This information is received from the UDR 203. The sending of this information can correspond to message 218 in FIG. 2.

In step 605 the PCF 202 sends a message (e.g. message 220 in FIG. 2) to a SMF 201. The message comprises (i) a first event trigger for the change in QoS that is based on the start time and/or duration; or (ii) a QoS for the SMF 201 to use for a session that is sent after the start time or on expiry of the duration.

The message sent to the SMF 201 may further comprise a QoS for the UE to be applied until the first event trigger occurs.

In some cases, after receiving a message from the SMF 201 indicating that the first event trigger for the change in QoS has occurred, the PCF 202 sends a further message to the SMF 201 indicating a changed QoS to be used for the UE. The further message to the SMF 201 may include a second event trigger relating to the end of the QoS change.

FIG. 7 is a flow chart illustrating a method of operating a SMF 201 to effect a change in QoS for a UE. The method may be performed by a SMF node 201, or a general network node configured to operate as a SMF 201. The SMF/network node 201 may perform the method in response to executing suitably formulated computer readable code. The computer readable code may be embodied or stored on a computer readable medium, such as a memory chip, optical disc, or other storage medium. The computer readable medium may be part of a computer program product.

In step 701 the SMF 201 receives a message (e.g. message 220 in FIG. 2) comprising a first event trigger for the change in QoS that is based on a start time for the change in QoS for the UE and/or a duration of the change in QoS for the UE. This message is received from PCF 202.

In step 703 the SMF 201 establishes a data session for the UE and monitors for occurrence of the first event trigger.

In step 705, which occurs after the first event trigger occurs, the SMF 201 sends a request to the PCF 202 to reauthorise the data session.

Subsequently, in step 707, the SMF 201 receives updated policy data for the UE that effects the change in QoS from the PCF 202.

The message received from the PCF 202 in step 701 may also include a QoS for the UE to be applied to the established data session until the first event trigger occurs.

The received updated policy data may further comprise a second event trigger relating to the end of the QoS change.

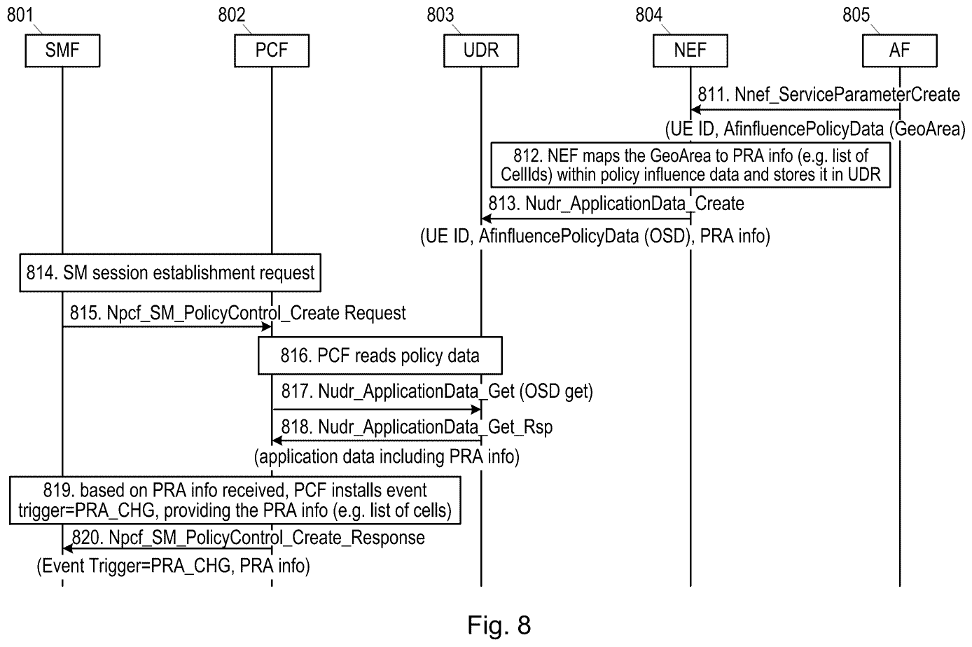

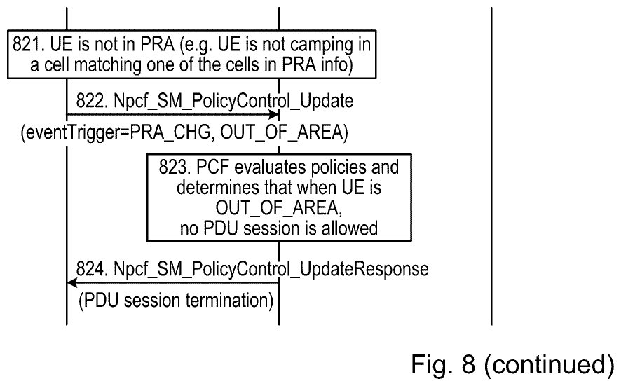

FIG. 8 is a signalling diagram illustrating the signalling between different network functions according to the disclosed techniques in order to provide the ability to have local SIMs/UEs that provide data connectivity only when the SIM/UE is in a particular geographical area. Then, only when the SIM/UE enters or is in that geographical area, the data connectivity is allowed. Otherwise, if they are outside the associated “home” geographical area, data connectivity is forbidden or restricted (e.g. to certain services, lower QoS, additional charging, etc). This second example results in the network operator requesting the possibility to assign presence reporting areas (PRAs) to specific UEs in a dynamic fashion, so that the PCF evaluates policies based on this/these PRAs.

FIG. 8 shows the signalling between an SMF 201, PCF 202, UDR 203, NEF 204 and AF 205.

At step 811, the AF 205 sends a message to the NEF 204 that identifies the affected UE(s), and indicates the geographic area in which data connectivity is permitted (or alternatively indicate a geographic area in which data connectivity is prevented). In some embodiments, the geographic information can identify one or more cells or base station of the network in which this policy (data/no data) is to be applied. In some embodiments, the geographic information can be in the form of a set of coordinates, e.g. latitude, longitude, defining a boundary of the geographic area. This geographic information is generally referred to as AF influence policy data (i.e. data from the AF 205 that is used to influence policy) or AfInfluencePolicyData. In some embodiments, the message sent by the AF 205 in step 811 can call the Nnef_Service_Parameter API, and can be a Nnef_ServiceParameterCreate message. The geographic area information is denoted “GeoArea” in FIG. 8.

At step 812 the NEF 204 maps the geographic area information received from the AF 205 to PRA information, for example a list of the affected cells/base stations (e.g. a list of CellIDs). At step 812, the NEF 204 decides that the AF influence policy data/PRA information is to be stored in the UDR 203 and at step 813 the NEF 204 sends a message to the UDR 203 to store the AF influence policy data (PRA information) in the UDR 203.

The target resource/storage in the UDR 203 (e.g. /application-data or/policy-data) can either be based on a new local policy in the NEF 204, or be based on a response from a NRF when discovering UDRs (depending on whether a UDR service is discovered for application-data and the AF influence on policy data subset). The message sent by the NEF 204 to the UDR 203 can be a Nudr_ApplicationData_Create message and can include the AF influence policy data received from the AF 205.

At step 814, a new session management (SM) session for a UE is to be established, and in step 815 the SMF 201 sends a message to the PCF 202 to obtain policy information for the new SM session. A new SM session may be established when a UE is attached to the network and requests data connectivity. The message sent by the SMF 201 can be a Npcf_SM_PolicyControl_Create message.

Following receipt of the request from the SMF 201, in step 816 the PCF 202 determines that it needs to read the policy data and the application data for the UE that is stored in the UDR 203. In step 816 the PCF 202 obtains the policy data from the UDR 203, and in step 817 the PCF 202 sends a request to the UDR 203 for the policy and/or application data for the UE. This request can be a Nudr_ApplicationData_Get message.

In step 818 the UDR 203 sends the policy and/or application data for the UE to the PCF 202. In this embodiment, the policy and application data includes the PRA information or other form of geographical information. This data can be sent in a Nudr_ApplicationData_Get_Rsp message.

In step 819, based on the PRA/other geographical information, the PCF 202 updates the policies in the SMF 201 to include an event that is triggered by a change of the PRA of the UE (event =PRA change) and includes the PRA information (or other geographical information). This is shown by the PCF 202 sending a message to the SMF 201 in step 820 indicating the PRA_CHG event trigger and the PRA information. Thus, the SMF 201 will report to the PCF 202 when the UE enters or leaves the PRA (e.g. when the UE enters any of the cells in the list). The message sent in step 820 can be a Npcf_SM_PolicyControl_Create Response message.

The reporting to the SMF 201 by the PCF 202 when the UE enters or leaves the PRA is shown in steps 821-824. In particular, at step 821 the UE is not in the PRA (e.g. the UE is not/no longer camping in a cell matching one of the cells in the PRA information), and so in step 822 the SMF 201 can send a message to the PCF 202 indicating that the UE is out of the PRA area. The message sent in step 822 can be a Npcf_SM_PolicyControl_Update message, and it can indicate the event that has been triggered, and the current state (e.g. UE out of area).

After receiving message 822, the PCF 202 evaluates the policies and determines that (in this embodiment) when the UE is outside the PRA, no data connectivity is permitted (i.e. no PDU sessions). In that case in step 824 the PCF 202 sends a message to the SMF 201 indicating that any existing data connection is to be ended or terminated. This message can be a Npcf_SM_PolicyControl_Update_Rsp message.

In response to this message, the SMF 201 can terminate any data connection with the UE.

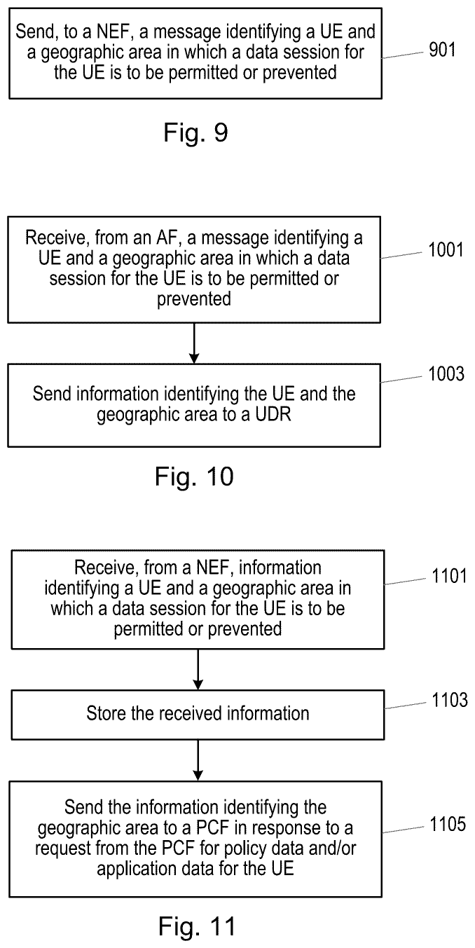

FIG. 9 is a flow chart illustrating a method of operating an AF 205 to effect control of data sessions according to location of a UE. The method may be performed by an AF node 205, or a general network node configured to operate as an AF 205. The AF/network node 205 may perform the method in response to executing suitably formulated computer readable code. The computer readable code may be embodied or stored on a computer readable medium, such as a memory chip, optical disc, or other storage medium. The computer readable medium may be part of a computer program product.

In step 901, the AF 205 sends a message to NEF 204. The message (e.g. message 811 in FIG. 8) identifies the UE and a geographic area in which a data session for the UE is to be permitted or prevented.

The geographic area may be identified using coordinates and/or by cell and/or base station identifiers.

FIG. 10 is a flow chart illustrating a method of operating a NEF 204 to effect control of data sessions according to location of a UE. The method may be performed by a NEF node 204, or a general network node configured to operate as a NEF 204. The NEF/network node 204 may perform the method in response to executing suitably formulated computer readable code. The computer readable code may be embodied or stored on a computer readable medium, such as a memory chip, optical disc, or other storage medium. The computer readable medium may be part of a computer program product.

In step 1001, the NEF 204 receives a message (e.g. message 811 in FIG. 8) from AF 205 identifying the UE and a geographic area in which a data session for the UE is to be permitted or prevented.

In step 1003, the NEF 204 sends information identifying the UE and the geographic area to UDR 203 (e.g. as shown by message 813 in FIG. 8).

FIG. 11 is a flow chart illustrating a method of operating a UDR 203 to effect control of data sessions according to location of a UE. The method may be performed by a UDR node 203, or a general network node configured to operate as a UDR 203. The UDR/network node 203 may perform the method in response to executing suitably formulated computer readable code. The computer readable code may be embodied or stored on a computer readable medium, such as a memory chip, optical disc, or other storage medium. The computer readable medium may be part of a computer program product.

In step 1101, the UDR 203 receives information (e.g. via message 813 in FIG. 8) from NEF 204 identifying the UE and a geographic area in which a data session for the UE is to be permitted or prevented.

In step 1103 the UDR 203 stores the received information.

In step 1105, the UDR 203 sends the information identifying the geographic area to PCF 202 in response to a request from the PCF 202 for policy data and/or application data for the UE. The sending of this information can correspond to message 818 in FIG. 8).

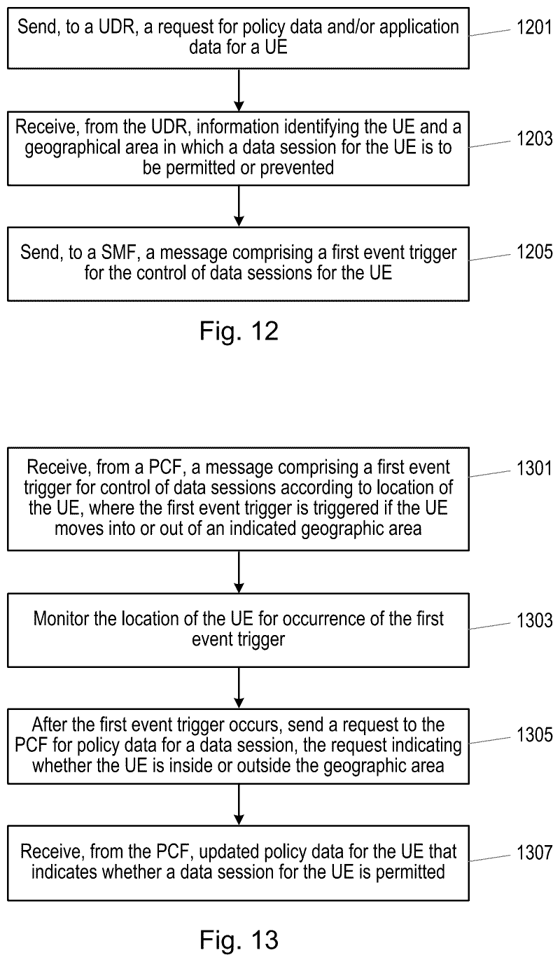

FIG. 12 is a flow chart illustrating a method of operating a PCF 202 to effect control of data sessions according to location of a UE. The method may be performed by a PCF node 202, or a general network node configured to operate as a PCF 202. The PCF/network node 202 may perform the method in response to executing suitably formulated computer readable code. The computer readable code may be embodied or stored on a computer readable medium, such as a memory chip, optical disc, or other storage medium. The computer readable medium may be part of a computer program product.

In step 1201, the PCF 202 sends a request to UDR 203 for policy data and/or application data for the UE. This request can correspond to message 817 in FIG. 8.

In step 1203, the PCF 202 receives information from the UDR 203 (e.g. via message 818 in FIG. 8) that identifies the UE and a geographical area in which a data session for the UE is to be permitted or prevented.

In step 1205, the PCF 202 sends a message (e.g. message 820 in FIG. 8) to SMF 201. This message comprises a first event trigger for the control of data sessions for the UE. The first event trigger may be such that the first event trigger is triggered if the UE moves into or out of the geographic area.

After receiving a message from the SMF 201 indicating that the first event trigger has occurred, the PCF 202 may determine whether a data session is permitted or not according to the location of the UE relative to the geographic area. Then, according to the result of the determining, the PCF 202 sends a further message to the SMF indicating whether the data session is permitted or not.

The information received from the UDR 203 may comprise information identifying a geographic area in which data sessions are permitted for the UE. In this case, it is determined that a data session is permitted if the location of the UE is in the geographic area, and otherwise it is determined that a data session is not permitted or a data rate for the data session is to be reduced.

Alternatively, the information received from the UDR 203 can comprise information identifying a geographic area in which data sessions are not permitted for the UE. In this case, it is determined that a data session is not permitted if the location of the UE is in the geographic area, and otherwise it is determined that a data session is permitted.

FIG. 13 is a flow chart illustrating a method of operating a SMF 201 to effect control of data sessions according to location of a UE. The method may be performed by a SMF node 201, or a general network node configured to operate as a SMF 201. The SMF/network node 201 may perform the method in response to executing suitably formulated computer readable code. The computer readable code may be embodied or stored on a computer readable medium, such as a memory chip, optical disc, or other storage medium. The computer readable medium may be part of a computer program product.

In step 1301, the SMF 201 receives a message (e.g. message 820 in FIG. 8) from PCF 202 that comprises a first event trigger for the control of data sessions according to location of the UE. The first event trigger is to be triggered if the UE moves into or out of an indicated geographic area.

In step 1303, the SMF 201 monitors the location of the UE for occurrence of the first event trigger.

In step 1305, after the first event trigger occurs, the SMF 201 sends a request to the PCF 202 for policy data for a data session. This request can indicate whether the UE is inside or outside of the geographic area.

In step 1307, the SMF 201 receives updated policy data from the PCF 202 for the UE that indicates whether a data session for the UE is permitted.

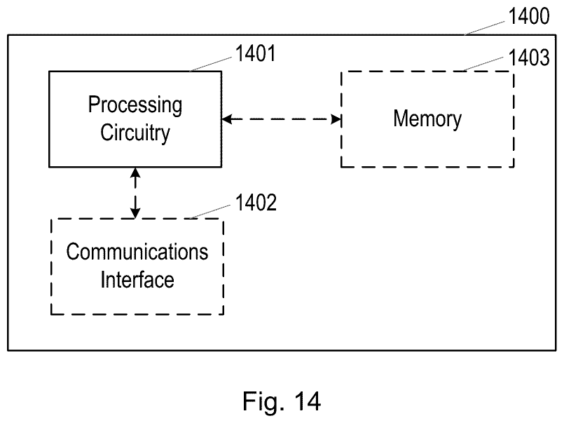

The techniques described herein can therefore be implemented by one or more network functions (NFs) in a network, such as a SMF, a PCF, a UDR and a NEF, and by an external AF. FIG. 14 is a simplified block diagram of a network node 1400 according to some embodiments that can be used to implement the techniques described herein. Any of the SMF, PCF, UDR, NEF, and AF can be implemented as a network node as shown in FIG. 14.

The network node 1400 comprises processing circuitry (or logic) 1401. It will be appreciated that the network node 1400 may comprise one or more virtual machines running different software and/or processes. The network node 1400 may therefore comprise, or be implemented in or as one or more servers, switches and/or storage devices and/or may comprise cloud computing infrastructure that runs the software and/or processes.

The processing circuitry 1401 controls the operation of the network node 1400 and can implement the methods described herein in relation to any of the SMF, PCF, UDR, NEF, and/or AF. The processing circuitry 1401 can comprise one or more processors, processing units, multi-core processors or modules that are configured or programmed to control the network node 1400 in the manner described herein. In particular implementations, the processing circuitry 1401 can comprise a plurality of software and/or hardware modules that are each configured to perform, or are for performing, individual or multiple steps of the methods described herein in relation to the SMF, PCF, UDR, NEF, and/or AF.

The network node 1400 may also comprise a communications interface 1402. The communications interface 1402 is for use in enabling communications with other nodes, such as any one or more of a SMF, PCF, UDR, NEF, and/or AF. For example, the communications interface 1402 can be configured to transmit to and/or receive from other nodes requests, acknowledgements, information, data, signals, or similar. The communication interface 1402 can use any suitable communication technology.

The processing circuitry 1401 may be configured to control the communications interface 1402 to transmit to and/or receive from other nodes requests, acknowledgements, information, data, signals, or similar, according to the methods described herein.

The network node 1400 may comprise a memory 1403. In some embodiments, the memory 1403 can be configured to store program code that can be executed by the processing circuitry 1401 to perform the method described herein in relation to the network node 1400. Alternatively or in addition, the memory 11403 can be configured to store any requests, acknowledgements, information, data, signals, or similar that are described herein. The processing circuitry 1401 may be configured to control the memory 1403 to store such information therein.

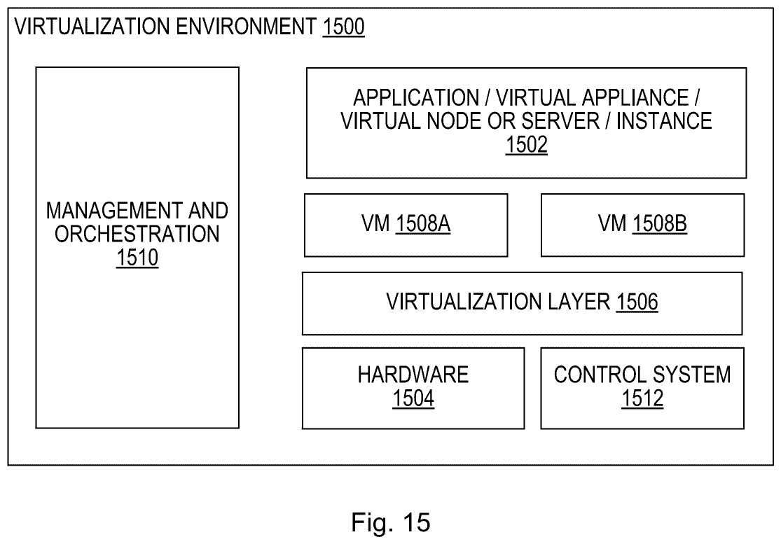

FIG. 15 is a block diagram illustrating a virtualization environment 1500 in which functions implemented by some embodiments may be virtualized. In the present context, virtualizing means creating virtual versions of network functions (e.g. a SMF, PCF, UDR, NEF, and/or AF), apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1500 hosted by one or more of hardware nodes, such as a hardware computing device that operates as an access network node, a wireless device/UE, or a core network node. Further, in embodiments in which the virtual node does not require radio connectivity (e.g. a core network node), then the node may be entirely virtualized.

Applications 1502 (which may alternatively be called software instances, virtual appliances, network functions, virtual nodes, virtual network functions, etc.) are run in the virtualization environment 1500 to implement some of the features, functions, and/or benefits of some of the embodiments disclosed herein.

Hardware 1504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1506 (also referred to as hypervisors or virtual machine monitors (VMMs)), provide VMs 1508a and 1508b (one or more of which may be generally referred to as VMs 1508), and/or perform any of the functions, features and/or benefits described in relation with some embodiments described herein. The virtualization layer 1506 may present a virtual operating platform that appears like networking hardware to the VMs 1508.

The VMs 1508 comprise virtual processing, virtual memory, virtual networking or interface and virtual storage, and may be run by a corresponding virtualization layer 1506. Different embodiments of the instance of a virtual appliance 1502 may be implemented on one or more of VMs 1508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1508 may be a software implementation of a physical machine that runs programs as if they were executing on a physical, non-virtualized machine. Each of the VMs 1508, and that part of hardware 1504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1508 on top of the hardware 1504 and corresponds to the application 1502.

Hardware 1504 may be implemented in a standalone network node with generic or specific components. Hardware 1504 may implement some functions via virtualization. Alternatively, hardware 1504 may be part of a larger cluster of hardware (e.g. such as in a data center or customer premises equipment (CPE)) where many hardware nodes work together and are managed via management and orchestration 1510, which, among others, oversees lifecycle management of applications 1502. In some embodiments, hardware 1504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signalling can be provided with the use of a control system 1512 which may alternatively be used for communication between hardware nodes and radio units.

Although the computing devices described herein (e.g. NFs, network nodes) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the scope of the disclosure. Various exemplary embodiments can be used together with one another, as well as interchangeably therewith, as should be understood by those having ordinary skill in the art.

### REFERENCES

1. 3GPP TS 29.522 version 17.5.0: Network Exposure Function Northbound APIs
2. 3GPP TS 29.122 version 17.5.0: T8 reference point for Northbound APIs
3. 3GPP TS 29.508 version 17.7.0: 5G System; Unified Data Management Services; Stage 3

1. A method of operating Network Functions to effect a change in Quality of Service, QoS, for a User Equipment, UE, the method comprising:
sending from an Application Function, AF, in a communication network to a Network Exposure Function, NEF, in the communication network, a message comprising information identifying the UE and one or both of a start time for a change in QoS for the UE and a duration of the change in QoS for the UE.

2. A method as claimed in claim 1, wherein the message further comprises an indication of the change in QoS to be effected at the start time and/or for the duration.

3. A method as claimed in claim 1, wherein the change in QoS is an increase in data rate provided to the UE by the communication network.

4. A method as claimed in claim 1, wherein the method is performed in response to a request to the AF from a user of the UE to change the QoS.

5. A method as claimed in claim 1, further comprising: and
sending the information identifying the UE and the one or both of the start time and duration from the NEF to a Unified Data Repository, UDR, in the communication network.

6. A method as claimed in claim 5, further comprising:
storing the information by the UDR; and
sending the information identifying one or both of the start time and duration of the change in QoS for the UE from the UDR to a Policy and Charging Function, PCF, in the communication network in response to a request from the PCF for policy data and/or application data for the UE.

7. A method as claimed in claim 6, further comprising:
sending from the PCF to a Session Management Function, SMF, in the communication network a message comprising (i) a first event trigger for the change in QoS that is based on the start time and/or duration; or (ii) a QoS for the SMF to use for a session that is sent after the start time or on expiry of the duration.

8. A method as claimed in claim 7, wherein the message sent to the SMF further comprises a QoS for the UE to be applied until the first event trigger occurs.

9. A method as claimed in claim 7, wherein the method further comprises:
after receiving a message from the SMF indicating that the first event trigger for the change in QoS has occurred, sending a further message from the PCF to the SMF indicating a changed QoS to be used for the UE.

10. A method as claimed in claim 9, wherein the further message to the SMF (201) further comprises a second event trigger relating to the end of the QoS change.

11. A method as claimed in claim 7, for further comprising:
establishing, by the SMF, a data session for the UE and monitoring for occurrence of the first event trigger;
after the first event trigger occurs, sending a request from the SMF to the PCF to reauthorise the data session; and
receiving by the SMF from the PCF updated policy data for the UE that effects the change in QoS.

12. A method as claimed in claim 11, wherein the message from the PCF further comprises a QoS for the UE to be applied to the established data session until the first event trigger occurs.

13. A method as claimed in claim 11, wherein the received updated policy data further comprises a second event trigger relating to the end of the QoS change.

14-16. (canceled)

17. A method of operating Network Functions to effect control of data sessions according to location of a User Equipment, UE, the method comprising:
sending, from an Application Function, AF, in a communication network to a Network Exposure Function, NEF, in the communication network, a message comprising information identifying the UE and a geographic area in which a data session for the UE is to be permitted or prevented.

18. A method as claimed in claim 17, wherein the geographic area is identified using coordinates and/or by cell and/or base station identifiers.

19. A method as claimed in claim 17, further comprising:
sending the information identifying the UE and the geographic area from the NEF to a Unified Data Repository, UDR, in the communication network.

20. A method as claimed in claim 19. further comprising:
storing the received information by the UDR; and
sending the information identifying the geographic area from the UDR to a Policy and Charging Function, PCF, in the communication network in response to a request from the PCF (202) for policy data and/or application data for the UE.

21. A method as claimed in claim 20, further comprising:
and
sending from the PCF to a Session Management Function, SMF, in the communication network a message comprising a first event trigger for the control of data sessions for the UE.

22. (canceled)

23. A method as claimed in claim 21, wherein the method further comprises:
after receiving a message by the PCF from the SMF indicating that the first event trigger has occurred, determining by the PCF whether a data session is permitted or not according to the location of the UE relative to the geographic area; and
sending a further message by the PCF to the SMF indicating whether the data session is permitted or not according to the result of the determining.

24-25. (canceled)

26. A method as claimed in claim 21, of according further comprising:
monitoring, by the SMF, the location of the UE for occurrence of the first event trigger, wherein the first event trigger is to be triggered if the UE moves into or out of the geographic area;
after the first event trigger occurs, sending a request by the SMF to the PCF for policy data for a data session, wherein the request indicates whether the UE is inside or outside of the geographic area; and
receiving by the SMF from the PCF updated policy data for the UE that indicates whether a data session for the UE is permitted.

27-29. (canceled)
